(19) United States
(12) Patent Application Publication
(10) Pub. No.: US 2011/0175433 A1
(43) Pub. Date: Jul. 21, 2011

(54) TUBULAR PORTION OF BICYCLE HUB

(75) Inventor: PI-YUN CHIANG, Taichung Hsien (TW)

(73) Assignee: JOY INDUSTRIAL CO., LTD., TAICHUNG HSIEN (TW)

(21) Appl. No.: 12/782,742

(22) Filed: May 19, 2010

(30) Foreign Application Priority Data
Jan. 19, 2010 (TW) 099101354

(51) Int. Cl. B60B 27/00

(52) U.S. Cl. 301/110.5

(57) ABSTRACT

A bicycle hub includes a tubular portion which is fixed to the hub and includes at least one first transmission portion and at least one second transmission portion. The first transmission portion extends axially and radially outward from the tubular portion. The at least one second transmission portion includes at least one positioning protrusion on the tubular portion and at least one engaging member which has a first end mounted to the at least one positioning protrusion so as to form the at least one second transmission portion. Two sides of the at least one positioning protrusion are covered by the at least one engaging member. The at least one engaging member of the at least one second transmission portion provides dual-direction protection feature so as to reduce wearing when the flywheels 50 rotate.

### FIELD OF THE UTILITY MODEL

The present utility model relates to a bicycle hub, and more particularly, to a tubular portion of the rear wheel hub so as to bear the force applied thereto when the flywheels are rotated.

### BACKGROUND OF THE UTILITY MODEL

A conventional transmission system for a bicycle generally includes a chainwheel connected to the crank, a plurality of flywheels connected to one of two tubular portions of the rear wheel hub, and a chain connected between the chainwheel and the flywheels. The user treads the crank to rotate the chainwheel and the flywheels are rotated by the chain so that the rear wheel is rotated to move the bicycle forward.

Generally, there are three chainwheels connected to the crank and 5 to 10 flywheels connected to the rear wheel hub. The chain is moveably between one of the chainwheels and one of the flywheels to generate different teeth ratio so as to drive the bicycle in different ways.

The flywheels are connected to the tubular portion of the rear wheel hub so that when the flywheels rotate, the rear wheel hub drives the rear wheel. The engagement between the tubular portion and the flywheels includes multiple ridges engaged with grooves, the contact areas between the tubular portion and the flywheels transfer the force to rotate the rear wheel.

There are two systems for the connection between the hub and the flywheels, the first is the brand name “SHIMANO” and the second is the brand name “CAMPAGNOLO”, the difference between the two systems is the way the that the flywheels and the hub. Both systems transfer the force from the flywheels to the hub so as to rotate the rear wheel.

The conventional hub includes ridges on the outside of the tubular portion thereof and the flywheels include notches which accommodate the ridges so that the flywheels are connected to the hub. However, the direct contact between the surface of the ridges and the notches wears severely so that gaps are formed between the surface of the ridges and the notches. The gaps cause noise and uncertainty between the flywheels and the hub.

One of the improved utility models to protect the hub includes a flange on the tubular portion of the hub which has multiple stops and a positioning ridge protruding from the outer surface of the tubular portion. The stops includes protection member connected to at least one side thereof and the material of the protection member is different from the tubular portion.

Another one of the improved utility models to protect the hub includes multiple ridges extending axially on the outside of the tubular portion of the hub and the ridges are parallel to each other. At least one flywheel is mounted to the tubular portion and engaged with the ridges so that the rotation of the flywheel drives the rear wheel. At least one of the ridges includes an reinforcement member which includes an operation side and a connection side. The flywheel contacts the operation side when the flywheel rotates, and the connection side contacts the ridge. The force from the flywheel is transferred to the reinforce member and to the tubular portion of the hub.

For the first improved utility model, a protection member made of hard metal is connected to one side of the stop so as to bear impact and force when the flywheel rotates. For the second improved utility model, the driving force from the chainwheel is directly transferred to the reinforcement member.

However, the flange and the stop of the first improved utility model are located at one end of the hub and only part of the flange is connected with the stop. The protection member is located at a distance from the connection between the flange and the stop, so that a gap may be formed at the distal end of the protection member and the stop. Furthermore, most of the bicycles have only one valid transmission direction and the rotation in the other direction does not transfer the force to the rear wheel. Therefore, neither of the two systems is suitable to the bicycles which can be operated in both directions.

The present utility model intends to provide a tubular portion of a hub wherein the two sides of the ridges are protected when the flywheel rotates in whichever direction.

### SUMMARY OF THE UTILITY MODEL

The present utility model relates to a bicycle hub and comprises a tubular portion which has a first end fixed to the hub and at least one first transmission portion and at least one second transmission portion, wherein the first transmission portion is integrally formed on an outer surface of the tubular portion and extends axially from the first end of the tubular portion to a second end of the tubular portion. The at least one first transmission portion also extends radially outward from the outer surface of the tubular portion. The at least one second transmission portion is connected to the outer surface of the tubular portion and includes at least one positioning protrusion which is integrally formed with the tubular portion. At least one engaging member has a first end mounted to the at least one positioning protrusion so as to form the at least one second transmission portion. Two sides of the at least one positioning protrusion are covered by the at least one engaging member. The at least one second transmission portion provides protection to the tubular portion on the hub. The connection of the at least one second transmission portion is also suitable to the bicycles which can drive in two directions.

The primary object of the present utility model is to provide a tubular portion on a hub and which has a protection mechanism to reduce wearing between the tubular portion and the flywheels when the flywheels rotate in either direction.

Another object of the present utility model is to provide a tubular portion on a hub and which can be used on bicycles with or without derailleur system, and also suitable for being installed one either side of the bicycle frame.

Yet another object of the present utility model is to provide a tubular portion on a hub, wherein the installation of the first and second transmission portions is easy and quick.

The present utility model will become more obvious from the following description when taken in connection with the accompanying drawings which show, for purposes of illustration only, a preferred embodiment in accordance with the present utility model.

### BRIEF DESCRIPTION OF THE DRAWINGS

FIG. 1 is a perspective view to show the bicycle hub of the present utility model;

FIG. 2 is an exploded view to show the bicycle hub of the present utility model;

FIG. 3 shows a partial cross sectional view of the bicycle hub of the present utility model;

FIG. 4 is an end cross sectional view of the bicycle hub of the present utility model;

FIG. 5 is a perspective view to show the second embodiment of the bicycle hub of the present utility model;

FIG. 6 is an exploded view to show the second embodiment of the bicycle hub of the present utility model;

FIG. 7 shows a partial cross sectional view of the second embodiment of the bicycle hub of the present utility model;

FIG. 8 is an exploded view to show the third embodiment of the bicycle hub of the present utility model;

FIG. 9 shows a partial cross sectional view of the third embodiment of the bicycle hub of the present utility model;

FIG. 10 is a perspective view to show the fourth embodiment of the bicycle hub of the present utility model;

FIG. 11 is an exploded view to show the fourth embodiment of the bicycle hub of the present utility model;

FIG. 12 shows a partial cross sectional view of the fourth embodiment of the bicycle hub of the present utility model;

FIG. 13 is a perspective view to show the fifth embodiment of the bicycle hub of the present utility model;

FIG. 14 is an exploded view to show the fifth embodiment of the bicycle hub of the present utility model, and

FIG. 15 shows a partial cross sectional view of the fifth embodiment of the bicycle hub of the present utility model.

### DETAILED DESCRIPTION OF THE PREFERRED EMBODIMENT

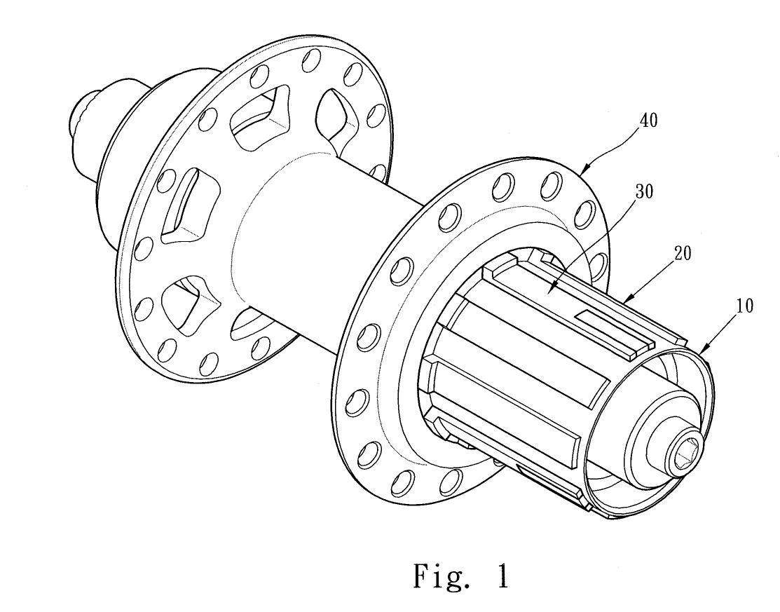

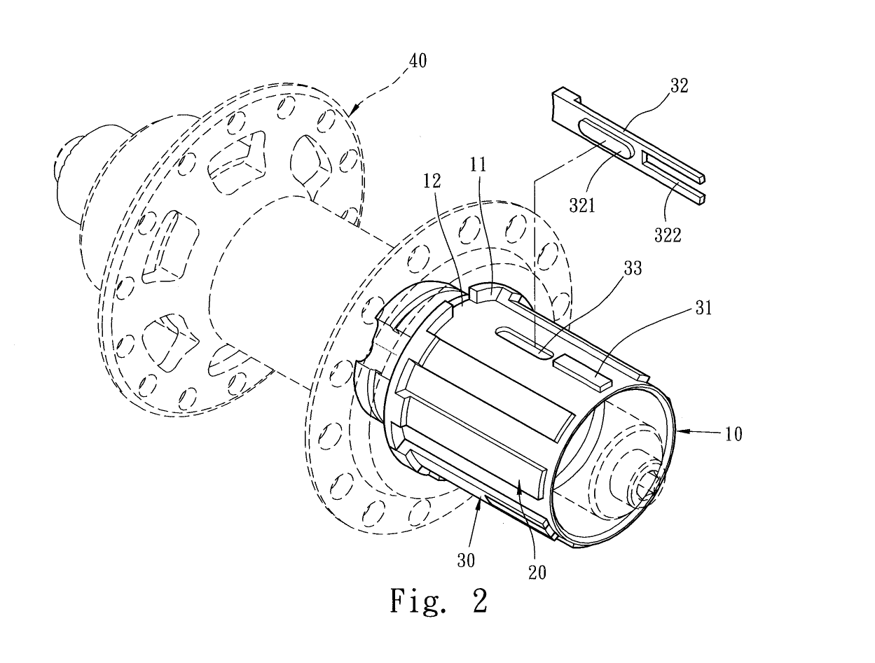

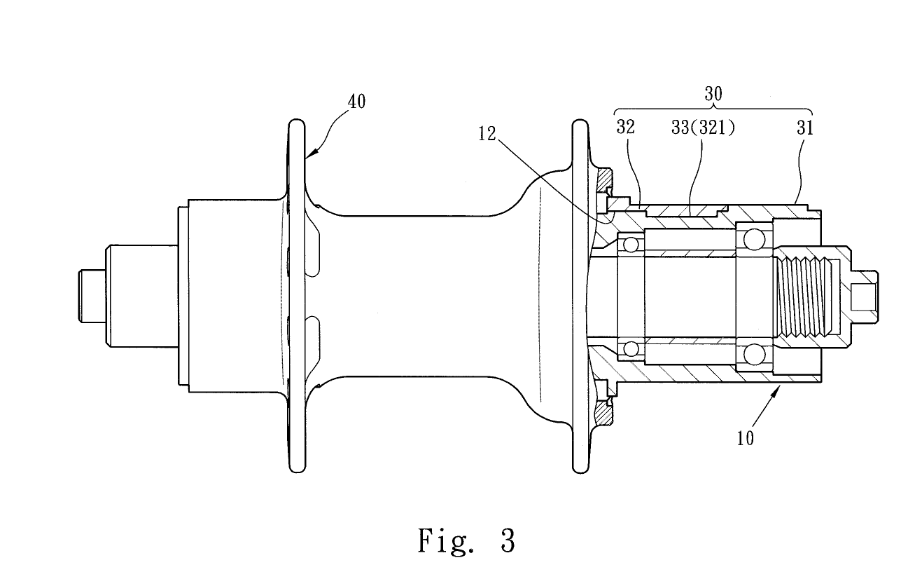

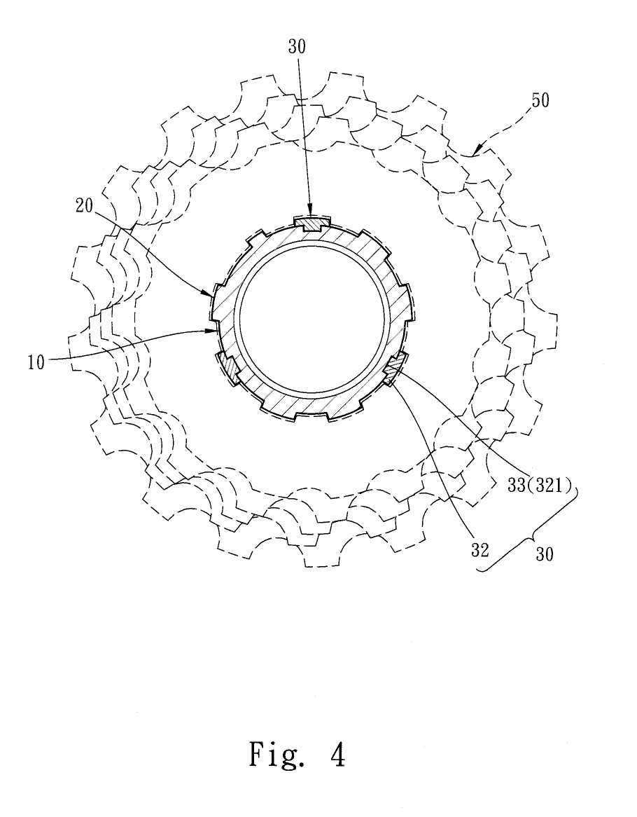

Referring to FIGS. 1 to 4, the bicycle hub of the present utility model is mainly designed for the system of the brand name “SHIMANO”, and comprises an elongate portion with two tubular portions 10 extending from two ends thereof. One of the tubular portions 10 has a first end fixed to the elongate portion of the hub 40 and is a hollow tube. Six first transmission portions 20 and three second transmission portions 30 are respectively connected to the tubular portion 10.

A flange 11 extends radially outward from the first end of the tubular portion 10 and an outer diameter of the flange 11 is larger than that of the tubular portion 10. A notch 12 is defined in the flange 11.

Each of the first transmission portions 20 is integrally formed on an outer surface of the tubular portion 10 and extends axially from the first end of the tubular portion 10 to a second end of the tubular portion 10. Each of the first transmission portions 20 also extends radially outward from the outer surface of the tubular portion 10.

Each of the second transmission portions 30 is connected to the outer surface of the tubular portion 10 and extends outward from the outer surface of the tubular portion 10. Each second transmission portion 30 has a positioning protrusion 31 which is integrally formed with the tubular portion 10. An engaging member 32 has a first end mounted to the positioning protrusion 31 so as to form the second transmission portion 30. Each of the second transmission portions 30 has a positioning recess 33 defined in the outer surface of the tubular portion 10 and the engaging member 32 has an engaging block 321 which is engaged with the positioning recess 33.

A positioning recess 33 is defined in the outer surface of the tubular portion 10 and the engaging member 32 has an engaging block 321 which is engaged with the positioning recess 33. The engaging member 32 includes an engaging recess 322 with which the positioning protrusion 31 is engaged. In this embodiment, the engaging recess 322 is a U-shaped recess. The engaging member 32 is in flush with the flange 11.

The first transmission portions 20 and the second transmission portions 30 are located on the outer surface of the tubular portion in pre-set number, pre-set arrangement and pre-set distance. The engaging members 32 of the second transmission portions 30 provide protection to the positioning protrusions 31 so as to reduce wearing when operation.

The two sides of the positioning protrusion 31 are covered by the engaging member 32 and the second end of the engaging member 32 is engaged with the notch 12.

The second transmission portions 30 are composed of the positioning protrusions 31 and the engaging members 32 engaged with the positioning protrusions 31, wherein the two sides of the positioning protrusions 31 are covered by the engaging members 32 engaged with the positioning protrusions so that the two sides of the positioning protrusions 31 are protected by the engaging members 32 regardless of the directions of rotation of the flywheels 50. Therefore, the bicycle hub of the present utility model can be used on the bicycles with or without derailleur system, and the can be installed to either one of two sides of the bicycles. It is noted that the engaging members 32 can be easily and quickly installed to the hub 40.

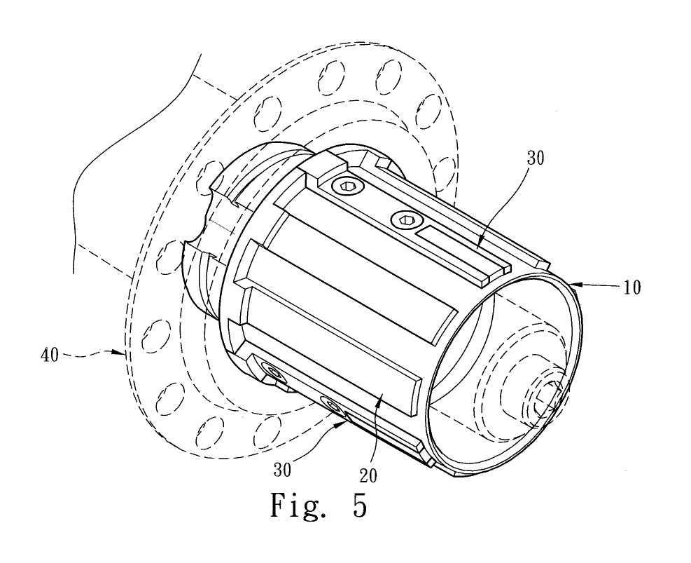

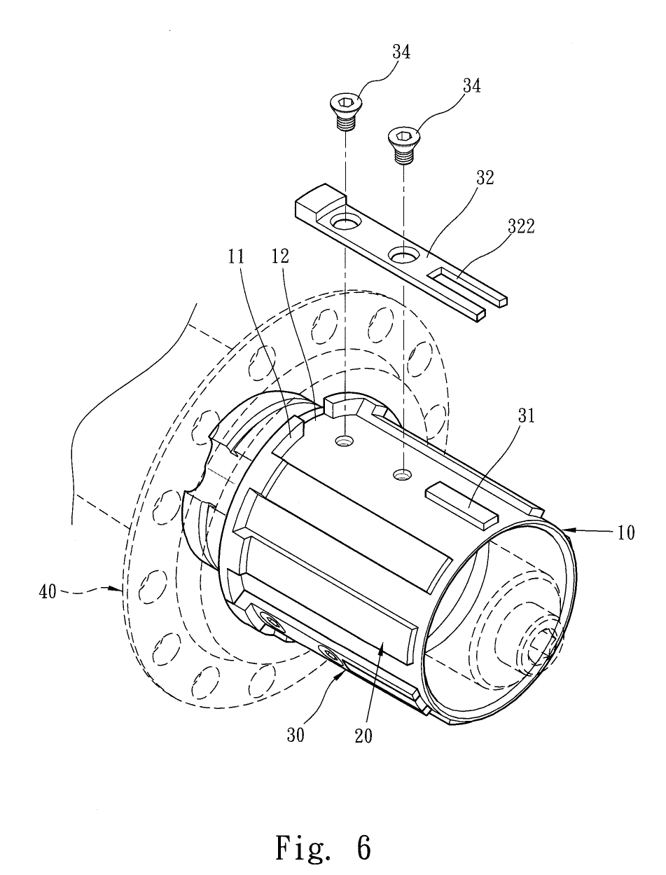

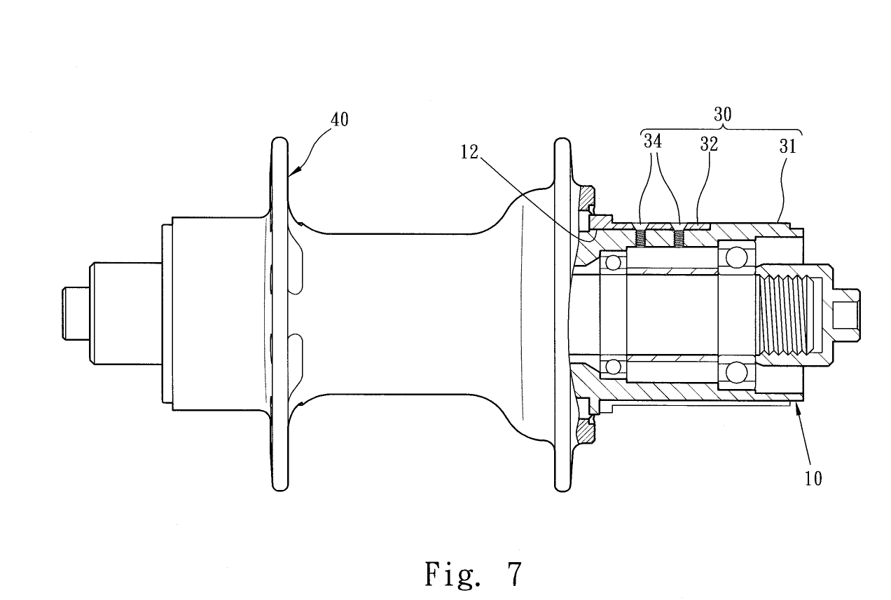

Referring to FIGS. 5 to 7, the second embodiment of the present utility model omits the positioning recess 33 and the engaging blocks 321 in the first embodiment, and further comprises two bolts 34 which extend through the engaging member 32 and the tubular portion 10 so as to fix the engaging member 32 to the tubular portion 10.

When installing the engaging member 32, the second end of the engaging member 32 is engaged with the notch 12 and the engaging recess 322 is defined in the first end of the engaging member 32 and the positioning protrusion 31 is engaged with the U-shaped engaging recess 322. The bolts 34 are then used to fix the engaging member 32 to the tubular portion 10. This embodiment reinforces the connection between the engaging member 32 and the tubular portion 10.

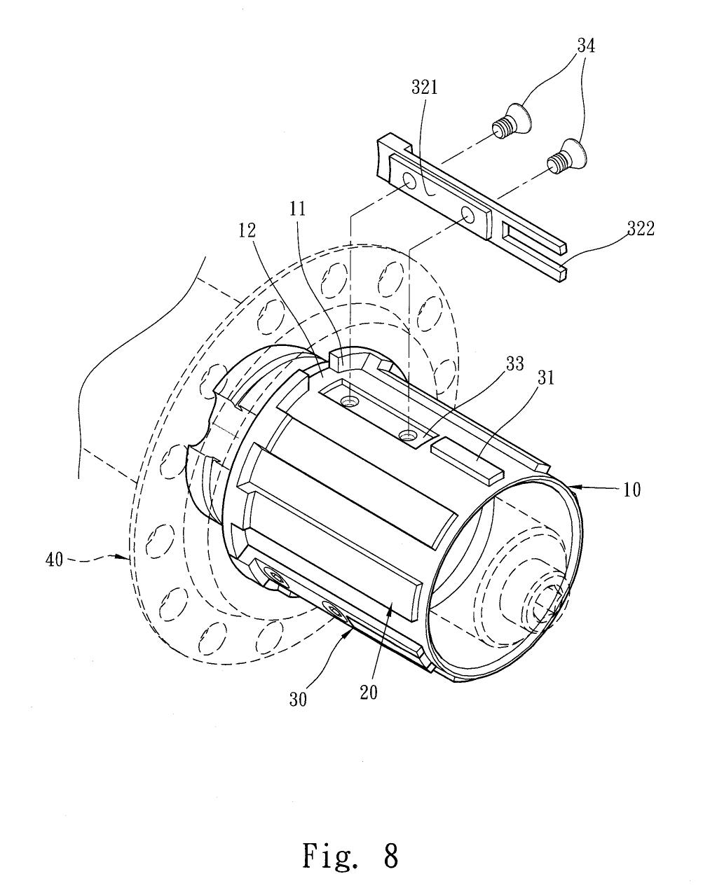

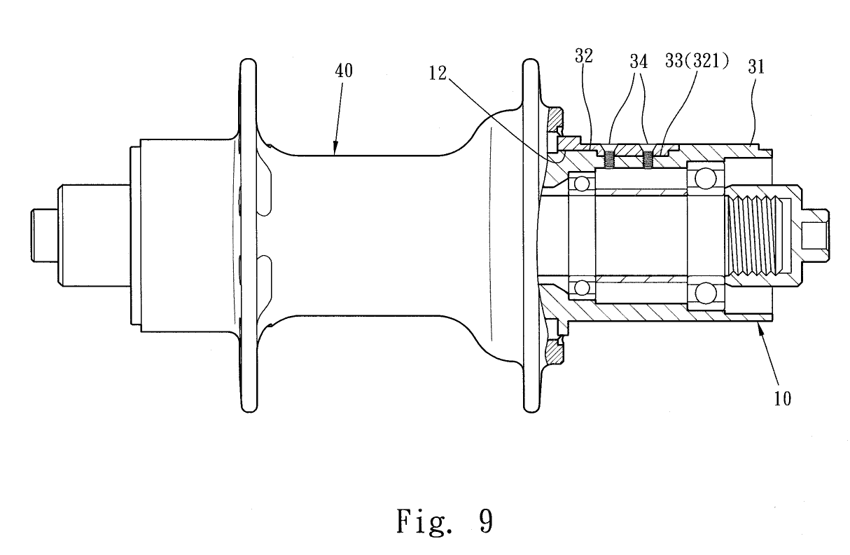

Referring to FIGS. 8 to 9, the third embodiment of the present utility model includes the positioning recess 33 and the engaging blocks 321 in the first embodiment, and further comprises two bolts 34 which extend through the engaging blocks 321 and the positioning recess 33 so as to fix the engaging member 32 to the tubular portion 10.

When installing the engaging member 32, the second end of the engaging member 32 is engaged with the notch 12 and the engaging recess 322 is defined in the first end of the engaging member 32 and the positioning protrusion 31 is engaged with the U-shaped engaging recess 322. The bolts 34 are then used to fix the engaging member 32 to the tubular portion 10. This embodiment reinforces the connection between the engaging member 32 and the tubular portion 10.

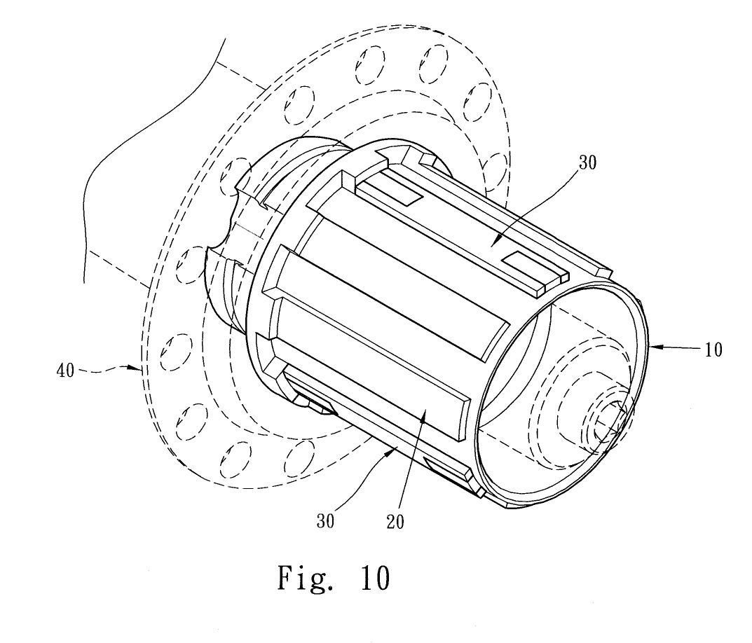

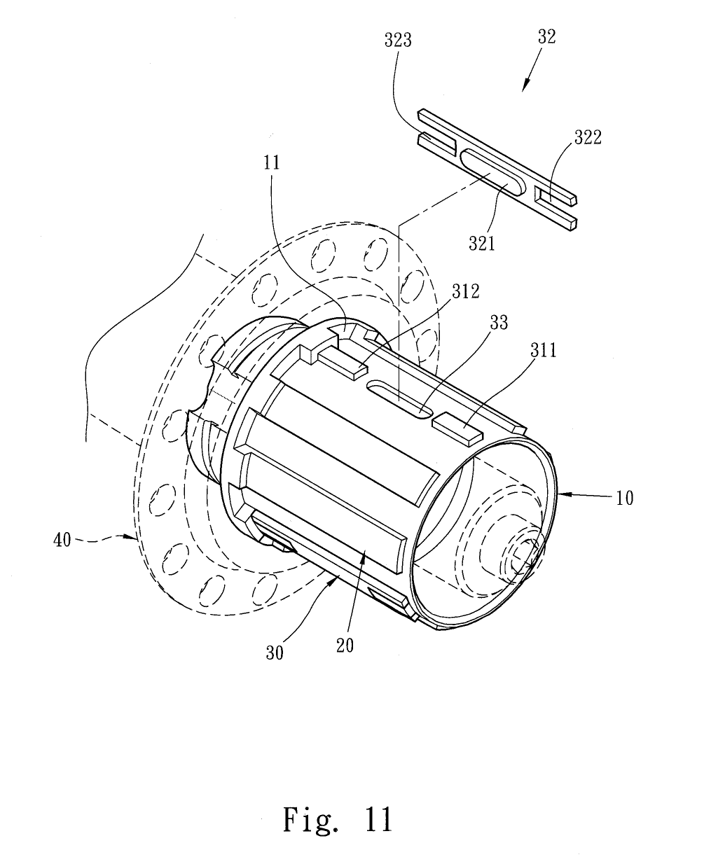

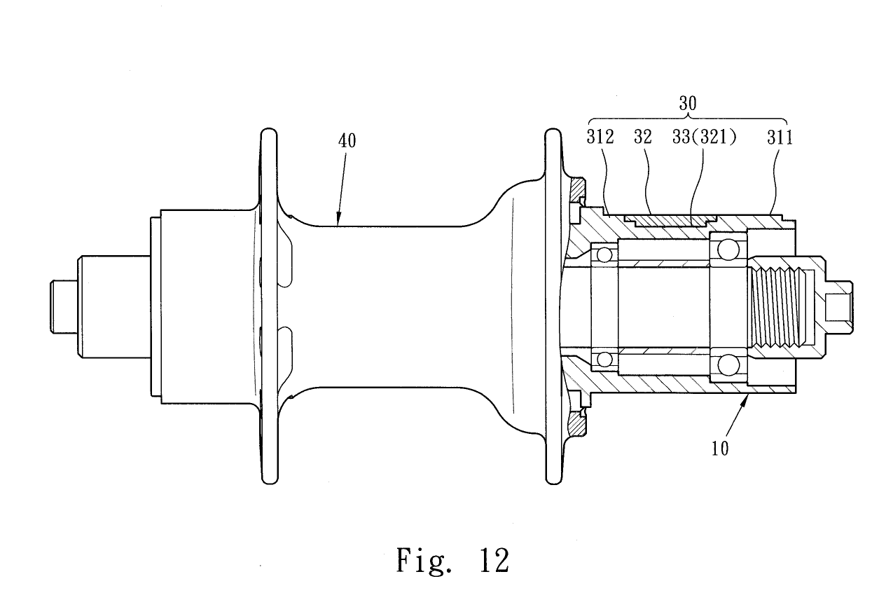

Referring to FIGS. 10 to 12, the fourth embodiment of the present utility model omits the notches 12 and includes the positioning recess 33 and the engaging blocks 321 in the first embodiment. The two positioning protrusions 311, 312 are located at a pre-set distance and one of the positioning protrusions 312 is located close to the flange 11. The engaging member 32 has two engaging recesses 322, 323 respectively defined in two ends thereof so as to be mounted to the two positioning protrusions 311, 312 respectively.

When installation, the two positioning protrusions 311, 312 are respectively engaged with the two engaging recesses 322, 323 of the engaging member 32, and the engaging block 321 is engaged with the positioning recess 33. This embodiment reinforces the connection between the engaging member 32 and the tubular portion 10. There is no notch 12 in this embodiment so that less machining process is required which saves cost.

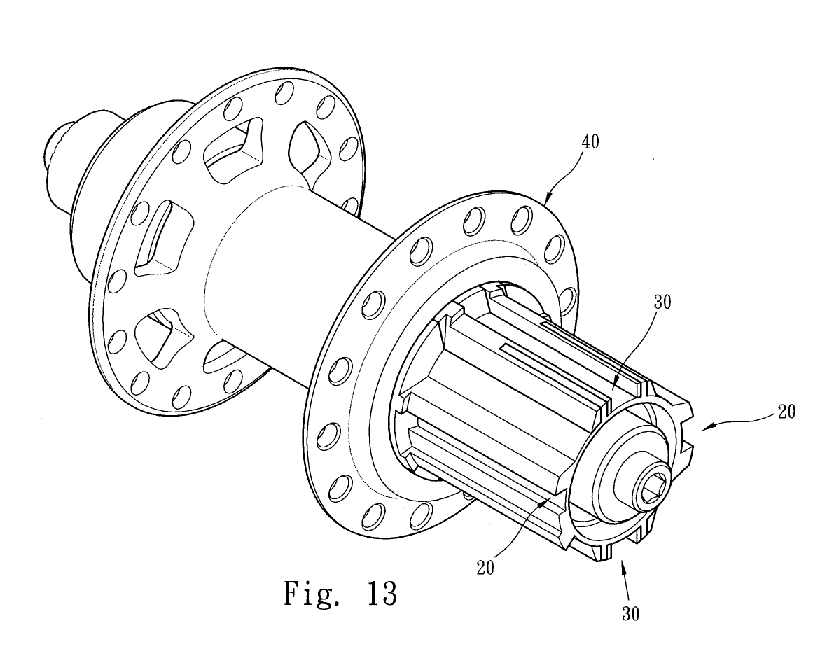

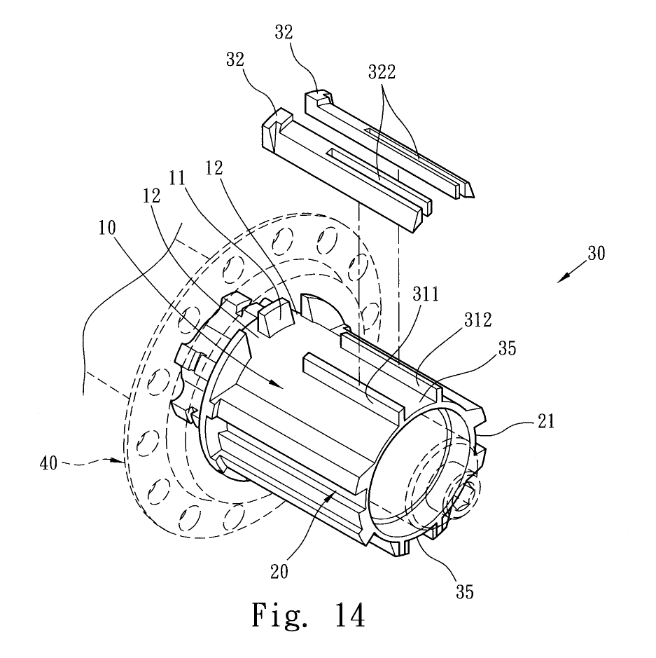

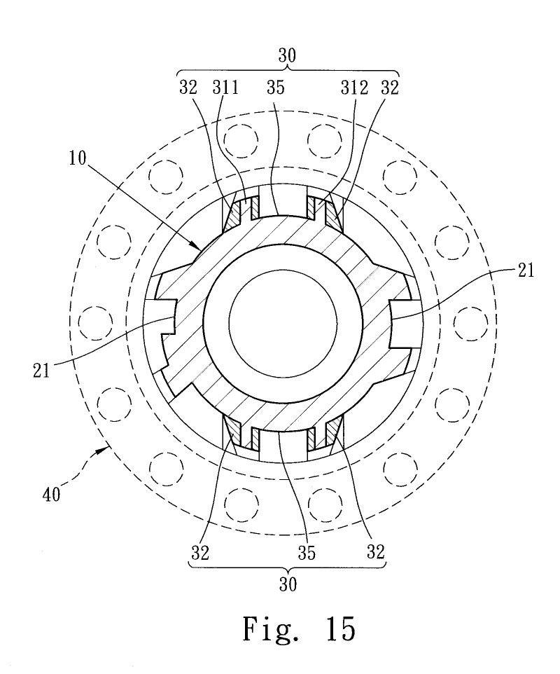

FIGS. 13 to 15 show the fifth embodiment of the present utility model which is designed to be cooperated with the system having the brand name “CAMPAGNOLO”, wherein it comprises two first transmission portions 20 and two second transmission portions 30, both of which are connected to the outer surface of the tubular portion 10. The first transmission portion 20 extends axially and radially outward from the outer surface of the tubular portion 10. Each first transmission portion 20 includes elongate ridges and a groove 21 is defined between the two ridges. Each second transmission portion 30 includes two positioning protrusions 311, 312 between which a gap is defined. Two engaging members 32 are respectively engaged with the two respective gaps of the two positioning protrusions 311. 312 so as to form the second transmission portion 30. A groove 35 is defined between the two engaging members 32. The tubular portion 10 includes the first transmission portions 20, the flange 11, two notches 12 and two positioning protrusions 311, 312. When installing the second transmission portions 30, the engaging members 32 each have one end engaged with the notch 12 and the other end includes an engaging recess 322 which is engaged with the positioning protrusion 311/312 corresponding thereto.

In this embodiment, the two engaging members 32 are engaged with the two second transmission portions 30 so as to be engaged with the flywheels of the system having the brand name “CAMPAGNOLO”.

While we have shown and described the embodiment in accordance with the present utility model, it should be clear to those skilled in the art that further embodiments may be made without departing from the scope of the present utility model.

What is claimed is:

1. A bicycle hub comprising:
an elongate portion and a tubular portion having a first end fixed to the hub, the tubular portion being a hollow tube;
at least one first transmission portion integrally formed on an outer surface of the tubular portion and extending axially from the first end of the tubular portion to a second end of the tubular portion, the at least one first transmission portion extending radially outward from the outer surface of the tubular portion, and
at least one second transmission portion connected to the outer surface of the tubular portion and extending outward from the outer surface of the tubular portion, the at least one second transmission portion having at least one positioning protrusion which is integrally formed with the tubular portion, at least one engaging member having a first end mounted to the at least one positioning protrusion so as to form the at least one second transmission portion, two sides of the at least one positioning protrusion being covered by the at least one engaging member, a second end of the at least one engaging member located close to the first end of the tubular portion.

2. The bicycle hub as claimed in claim 1, wherein the at least one first transmission portion and the at least one second transmission portion are located on the outer surface of the tubular portion in pre-set number, pre-set arrangement and pre-set distance.

3. The bicycle hub as claimed in claim 1, wherein at least one bolt extends through the at least one engaging member and the tubular portion so as to fix the at least one engaging member to the tubular portion.

4. The bicycle hub as claimed in claim 1, wherein the at least one second transmission portion has a positioning recess defined in the outer surface of the tubular portion and the at least one engaging member has an engaging block which is engaged with the positioning recess.

5. The bicycle hub as claimed in claim 4, wherein at least one bolt extends through the engaging block and the positioning recess to fix the at least one engaging member to the tubular portion.

6. The bicycle hub as claimed in claim 1, wherein the at least one engaging member includes at least one engaging recess with which the positioning protrusion is engaged.

7. The bicycle hub as claimed in claim 6, wherein the at least one engaging recess is a U-shaped recess and the positioning protrusion is engaged with at least one engaging recess.

8. The bicycle hub as claimed in claim 1, wherein a flange extends radially outward from the first end of the tubular portion and an outer diameter is larger than that of the tubular portion, a notch is defined in the flange and the second end of the at least one engaging member is engaged with the notch.

9. The bicycle hub as claimed in claim 1, wherein the at least one first transmission portion includes a groove and the at least second transmission portion includes two positioning protrusions between which a gap is defined, two engaging members are respectively engaged with the two respective gaps of the two positioning protrusions so as to form the second transmission portion, a groove is defined between the two engaging members.
